(19) United States
(12) Patent Application Publication
(10) Pub. No.: US 2007/0135989 A1
(43) Pub. Date: Jun. 14, 2007

(54) System and method for controlling vehicular traffic flow

(75) Inventor: Timothy M. Hengst, Palm Harbor, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/297,270

(22) Filed: Dec. 8, 2005

(51) Int. Cl. G08G 1/00

(52) U.S. Cl. 701/117

(57) ABSTRACT

A system and method for controlling vehicular traffic flow is disclosed, which creates a communication system between vehicles that allows the vehicles to share their respective velocities and acceleration or deceleration rates. Thus, each vehicle within the system can respond immediately to any acceleration or deceleration rate changes of the surrounding vehicles (e.g., the vehicle directly in front, directly in back, and in the adjacent lane). Essentially, the system functions similar to a wireless vehicular train, with a queue of cars linked together by a stiff, wireless communications “chain”. Notably, the term “vehicle” is not limited only to land-based vehicles (e.g., motor vehicles), and the system can include airborne vehicles (e.g., multiple aircraft flying in close formation, military aircraft flying in drone formation, etc.). For example, a system for controlling vehicular traffic flow is disclosed, which includes in each vehicle of a plurality of vehicles, a wireless or infrared (IR) modem for inter-vehicular communications, a range finder for determining the distance and closing rate between vehicles, a processing unit for retrieving vehicular operational data (e.g., velocity, angular velocity, acceleration rate, deceleration rate, braking pressure, weight, pointing vector, etc.) and executing flow control system software instructions, and a vehicular flow control communications protocol that enables the communication of various flow control parameters between vehicles via the wireless or IR modem. Thus, each vehicle in the system “knows” what the surrounding vehicles are doing and can respond immediately to changes in the traffic flow. As such, the system minimizes the distribution of vehicles' velocities in the queue, and increases traffic throughput and safety as a result.

### FIELD OF THE INVENTION

The present invention relates generally to the wireless networking field, and more specifically, but not exclusively, to a system and method for controlling vehicular traffic flow.

### BACKGROUND OF THE INVENTION

A slow down (or speed up) of queued motor vehicle traffic often creates what is known as the “slinky” effect. For example, if a blockage (accident, obstacle, etc.) impedes traffic flow in a lane, the vehicles in that lane have to merge with the flow of an adjacent lane. Consequently, long after the blockage is cleared, the perturbed lanes retain a “slinky” effect due to a “phantom” blockage caused by a large distribution of vehicles' velocities where the blockage actually occurred. In other words, a velocity wave is created when the vehicles in a queue are traveling at different speeds (e.g., some of the vehicles in the queue are stopped, accelerating, decelerating, or cruising at a constant speed). As such, the “slinky” effect is a significant traffic flow problem that often leads to rear-end collisions and other types of collisions, and traffic throughput is also decreased as a result.

Another significant traffic flow problem occurs if a vehicle immediately in front of another vehicle suddenly slows down or stops. For example, a “pile-up” can occur as the following vehicles sequentially rear-end each other. Also, if one or more vehicles swerve to avoid a collision, the swerving vehicles can cause a collision in the adjacent lane(s). Again, traffic throughput is also decreased as a result.

Yet another significant traffic flow problem occurs when a number of vehicles stopped in a queue (e.g., at a red light) begin accelerating (e.g., the light has changed to green). The vehicles in the queue start to accelerate, but not at the same rate. For example, as the vehicles begin to accelerate, they typically behave as if they are tied together with a slack rope (e.g., unlike a train with physically-connected queued cars). Thus, after the first of the vehicles in the queue begins to accelerate, there is a substantial lapse of time before the vehicles farther down in the queue can begin to move. Once again, traffic throughput is decreased as a result.

Still another significant traffic flow problem occurs when multiple stop lights are encountered by vehicles traveling in a queue. For example, along traffic arteries, multiple stop lights typically create a “pulsating” traffic flow. In other words, vehicles in the queue repetitively start and stop due to the large distribution in the vehicles' velocities (e.g. some vehicles are stopped, while other vehicles are moving). Consequently, the resulting “start 'n stop” traffic flow increases fuel consumption and brake wear, and throughput is also decreased as a result.

Other significant traffic flow problems also exist. For example, during poor driving conditions (e.g., fog, rain, snow, sleet), human responses to adverse events (e.g., accidents, obstacles, etc.) are severely limited by decreased visibility, which serves to increase stopping distance ranges and also decrease traffic safety as a result. Similarly, as traffic congestion is increased, the heightened risk avoidance tendencies of drivers have a progressively worsening effect on the amount of traffic congestion involved. Therefore, it would be advantageous to have a system and method for controlling vehicular traffic flow, which minimizes or eliminates the “slinky” effect, and similar traffic flow, throughput and safety problems. As described in detail below, the present invention provides such a system and method, which resolves the above-described traffic flow, throughput and safety problems and similar other problems.

### SUMMARY OF THE INVENTION

The present invention provides a system and method for controlling vehicular traffic flow, by creating a communication system between vehicles that allows the vehicles to share their respective velocities and acceleration or deceleration rates. Thus, each vehicle within the system can respond immediately to any acceleration or deceleration rate changes of the surrounding vehicles (e.g., the vehicle directly in front, directly in back, and in the adjacent lane). Essentially, the present invention provides a wireless vehicular train, with a queue of cars linked together by a stiff, wireless communications “chain”. Notably, the term “vehicle” is not limited only to land-based vehicles (e.g., motor vehicles), and the present invention can include within its scope airborne vehicles (e.g., multiple aircraft flying in close formation, military aircraft flying in drone formation, etc.). In accordance with a preferred embodiment of the present invention, a system for controlling vehicular traffic flow is provided, which includes in each vehicle of a plurality of vehicles, a wireless or infrared (IR) modem for inter-vehicular communications, a range finder for determining the distance and closing rate between vehicles, a processing unit for retrieving vehicular operational data (e.g., velocity, angular velocity, acceleration rate, deceleration rate, braking pressure, weight, pointing vector, etc.) and executing flow control system software instructions, and a vehicular flow control communications protocol that enables the communication of various flow control parameters between vehicles via the wireless or IR modem. Thus, each vehicle in the system “knows” what the surrounding vehicles are doing and can respond immediately to changes in the traffic flow. As such, the present invention minimizes the distribution of vehicles' velocities in the queue, and increases traffic throughput and safety as a result.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of an example system for controlling vehicular traffic flow, which can be used to implement a preferred embodiment of the present invention;

FIG. 2 depicts a block diagram of an example vehicle subsystem, which can be used to implement one or more of the vehicles of the system shown in FIG. 1;

FIG. 3 depicts an example vehicle autopilot system, which can be used to implement the vehicle subsystem in the embodiment shown in FIG. 2, or one or more of the vehicles in the embodiment shown in FIG. 1; and

FIG. 4 depicts a flowchart of an example method for controlling vehicle traffic flow, which can be used to implement pertinent autopilot software instructions that can be executed in the autopilot software unit in FIG. 2 or FIG. 3, in accordance with a preferred embodiment of the present invention.

### DETAILED DESCRIPTION OF PREFERRED EMBODIMENT

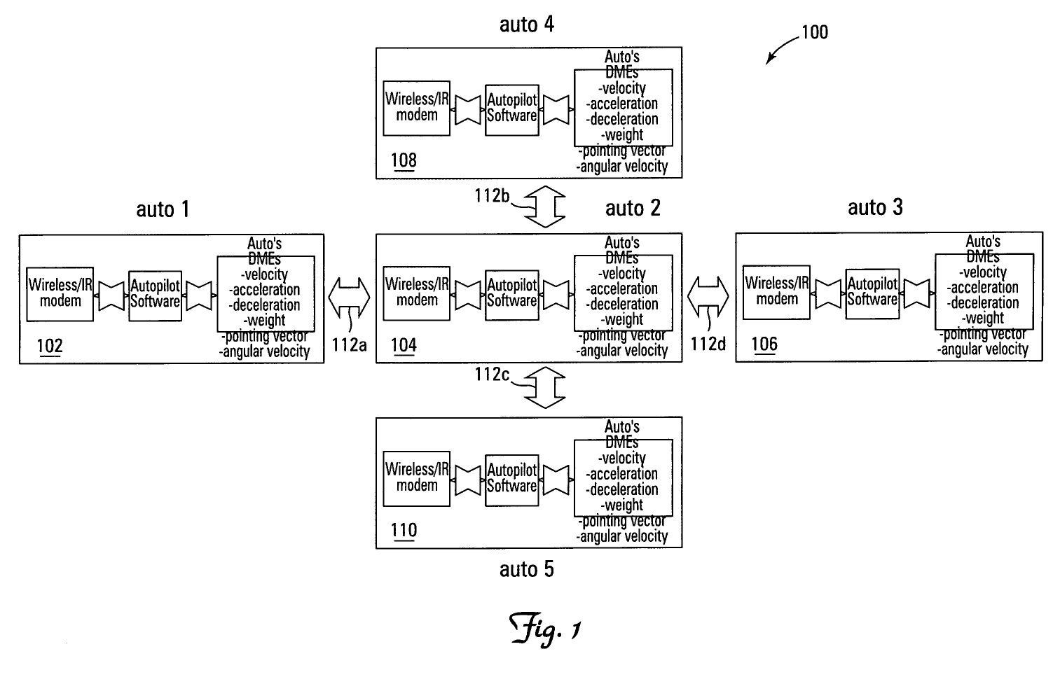

With reference now to the figures, FIG. 1 depicts a block diagram of an example system 100 for controlling vehicular traffic flow, which can be used to implement a preferred embodiment of the present invention. For this example embodiment, system 100 includes a plurality of automotive vehicles 102, 104, 106, 108, 110. Each vehicle 102-110 can communicate with at least one other vehicle 102-110 via a respective wireless communication link 112a-112d. For clarity and ease of understanding, it may be assumed that vehicles 102-110 are automobiles, but the present invention is not intended to be so limited and can include within its scope other types of vehicles that are typically arranged as queued vehicular traffic (e.g., trucks, buses, vans, motorcycles, etc.). Notably, the present invention also includes within its scope airborne vehicles (e.g., multiple aircraft flying in close formation, military aircraft flying in drone formation, etc.). Also, for this example, it may be assumed that vehicles 102, 104 and 106 are arranged in a single queue (e.g., traffic lane), with vehicle 102 first, vehicle 104 second, and vehicle 106 third in the queue. Also, each of vehicles 108 and 110 is arranged in a separate queue (e.g., lane), and each such queue is adjacent to that of vehicles 102, 104 and 106. Thus, for this example embodiment, each vehicle 102-110 is located in its respective lane, and the front of each such vehicle is directed towards the left side of FIG. 1.

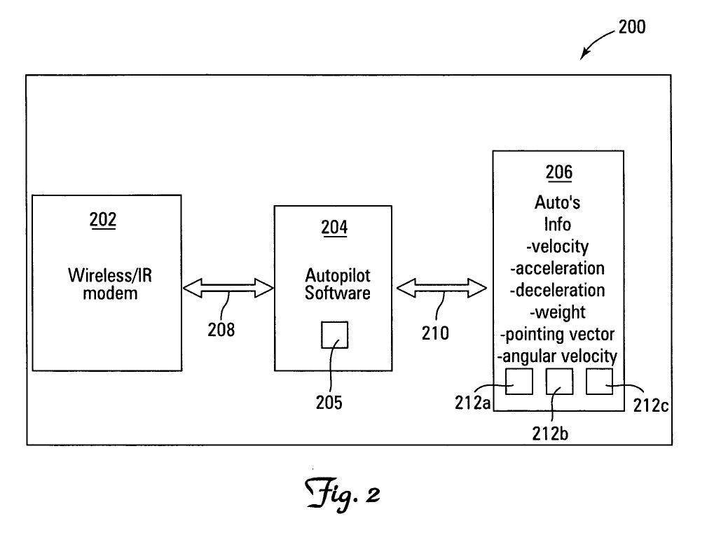

FIG. 2 depicts a block diagram of an example vehicle subsystem 200, which can be used to implement one or more of vehicles 102-110 of system 100 shown in FIG. 1. For this example embodiment, vehicle subsystem 200 includes a wireless or IR (transceiver) modem 202. Essentially, modem 202 enables vehicle 200 to communicate with another vehicle via that vehicle's wireless or IR modem (e.g., 202). In other words, wireless or IR modem 202 can provide an inter-vehicular wireless communication function for each link 112a-112d shown in FIG. 1. Notably, modem 202 can be implemented with a suitable wireless communication device, such as, for example, a programmable wireless cellular telephone. However, as described in detail below, for this example embodiment, modem 202 is preferably implemented with a suitable wireless internet data communication transceiver operating in accordance with the IEEE 802.11 b/g wireless data communication protocol. Thus, with such a wireless transceiver as wireless or IR modem 202, each of the vehicles 102-110 in system 100 is capable of communicating data to/from the other vehicles 102-110 via a form of wireless LAN. As described in detail below, for one example embodiment, a flow control message communication protocol is provided for communicating vehicular data between the particular vehicles involved.

For this example embodiment, subsystem 200 also includes an autopilot software unit 204. Autopilot software unit 204 includes a digital processor 205, which functions to execute suitable software instructions for controlling traffic flow (e.g., in system 100) by interpreting, processing and responding to vehicular operational data received from one or more other vehicles (e.g., via a wireless data communication link 112a-112 in FIG. 1) and/or received or retrieved internally from one or more Digital Motor Electronic (DME) systems of vehicle subsystem 200. An example of such software instructions for controlling traffic flow is described in detail below. Notably, in a second embodiment, wireless modem 202 and autopilot software unit 204 of subsystem 200 can be implemented in (or integrated into) a user's cellular phone, Personal Digital Assistant (PDA), or a similar wireless communication device. For example, existing cellular phones and PDAs include wireless transceivers that are capable of sending and receiving data such as vehicular operational data, and they also include suitable internal microprocessors for executing software instructions for controlling traffic flow.

As such, digital processor 205 can be a computer processor such as, for example, a microprocessor, digital signal processor, microcontroller, embedded processor, or a processor based on a PowerPC® processing architecture. Preferably, for this embodiment, digital processor 205 is implemented with one or more PowerPC embedded microcontrollers, or with one or more embedded processors running with a PowerPC-based Operating System (OS). For example, digital processor 205 can be arranged as a single processor or plurality of processors connected to a data communications bus or system bus. A memory controller/cache can also be connected to the data communications bus or system bus, which can provide an interface between digital processor 205 and a local memory (e.g., RAM, ROM, etc.). A plurality of machine instructions can be stored in the local memory and retrieved and operated on by digital processor 205 to, for example, retrieve or receive vehicular operational data associated with one or more vehicles' DME systems, and interpret, process, and respond to the vehicular operational data retrieved or received. An Input/Output (I/O) bus bridge can also be connected to the data communications bus or system bus, which can provide an interface between digital processor 205 and an I/O bus. Thus, digital processor 205 can receive, retrieve and/or send vehicular data via such an I/O bus (e.g., via data links 208 or 210). In any event, those of ordinary skill in the art will appreciate that the hardware described herein for digital processor 205 in FIG. 2 may vary. As such, the depicted example is provided for illustrative purposes and not meant to imply any architectural limitations with respect to the present invention.

For this example embodiment, vehicle subsystem 200 also includes a plurality of vehicle control modules 212a-212c. Although three vehicle control modules 212a-212c are shown, the present invention is not intended to be so limited, and can include any suitable number of vehicle control modules or similar vehicle operational monitoring equipment, such as, for example one or more DME systems, an Electronic Control Unit (ECU) to control engine operating parameters, an airbag control module to control the deployment of airbags, an Anti-Lock Braking System (ABS) module to control braking, an electronic traction-control or stability-control subsystem to improve handling, assist in cornering, and prevent skidding, an adjustable suspension subsystem to improve handling and ride comfort, and a transmission control module to control the shifting characteristics of the automatic transmission, just to name a few. Each such device, subsystem, ECU, and similar vehicle control module (e.g., 212a-212c) can contain one or more microprocessors capable of retrieving and storing a plurality of sensed vehicle operational parameters, and distributing (e.g., via wireless or IR modem 202) the operational parameters to other vehicles' systems in the traffic control network involved. For example, certain of vehicle control modules 212a-212c can monitor and retrieve such vehicular operational parameters as current velocity, acceleration rate, deceleration rate, weight, pointing vector, angular velocity, etc. Again, the depicted example is provided for illustrative purposes and not meant to imply any architectural limitations with respect to the present invention.

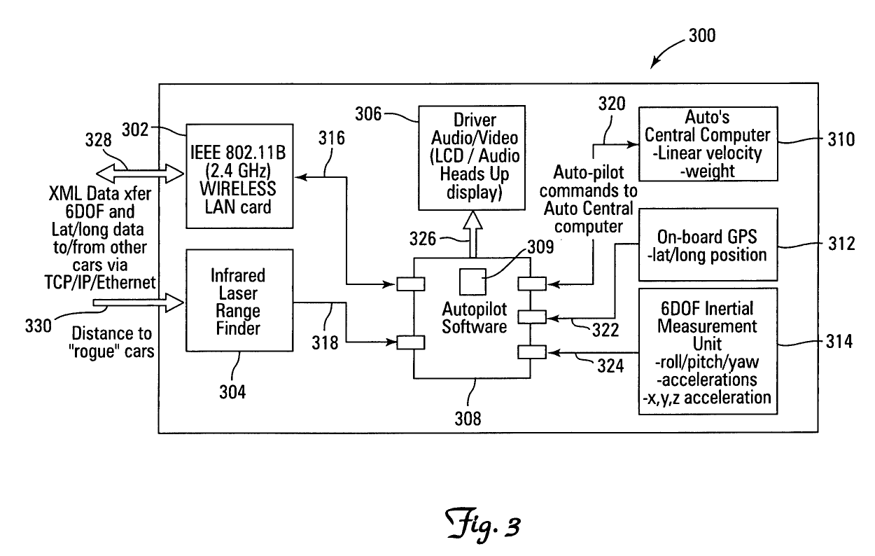

FIG. 3 depicts an example vehicle autopilot system 300, which can be used to implement vehicle subsystem 200 in the embodiment shown in FIG. 2, or one or more of vehicles 102-110 in the embodiment shown in FIG. 1. For this example embodiment, each vehicle's autopilot system (e.g., 300) in the vehicle traffic flow control system (e.g., system 100 in FIG. 1) can be identified with a unique Media Access Control (MAC) address or Internet Protocol (IP) address so that each such vehicle can be readily identified for data communication purposes. In any event, vehicle autopilot system 300 includes a wireless modem 302 (e.g., wireless transmitter/receiver) configured with a suitable wireless LAN card in order to operate at 2.4 GHz, and to communicate vehicular operational data in accordance with the IEEE 802.11b wireless data communications protocol. System 300 also includes an IR laser range finder unit 304, which functions to determine the distance (e.g., and closing rate) to a vehicle located substantially in front of a vehicle conveying system 300. Essentially, IR laser range finder unit 304 functions similar to a radar device, by transmitting an IR laser signal, receiving a return signal reflected from a second vehicle, and measuring the time difference between the transmitted and returned signals in order to determine the distance to that second vehicle (e.g., indicated as distance 330).

Notably, with a more sophisticated design, IR laser range finder unit 304 can be configured such that system 300 can use the Doppler phase-shift principle to determine the closing rate, if any, between itself and the vehicle directly in front. Also, as an alternative embodiment, wireless modem 302 can be configured as an IR modem, and it can communicate with the IR modem of a second vehicle directly in front of the vehicle conveying wireless modem 302. Thus, if both vehicles also include a GPS receiver (or other accurate positioning device), then system 300 can determine the distance between the two vehicles by use of the two vehicles' respective latitudinal and longitudinal coordinates, at any point in time.

For this example embodiment, system 300 also includes an operator display 306. For example, operator display 306 can provide traffic control information for an operator of a vehicle (that is conveying system 300) in a message format via a visual and/or audio display, such as an LCD display, an audio speaker, a heads-up display, or a heads-down display. In this manner, system 300 can alert the operator (e.g., driver) visually and/or audibly via display 306 about imminent traffic flow problems, such as “warning” information (e.g., excessive closing rate, imminent collision, etc.), vehicle position information, optimum speed needed to minimize the “slinky” effect, “slow down” or “speed up” messages, merge event information and instructions to move a vehicle to a merge “go to” point, etc. As an option, the operator display 306 can also provide an emergency vehicle over-ride message, which alerts the operators of pertinent vehicles in the traffic flow control system with a message broadcast from an emergency vehicle nearby the queued vehicles involved. This feature can reduce the emergency vehicles' response times, and minimize the potential for collisions caused by improper driver reactions to the approaching emergency vehicle.

For this example embodiment, system 300 also includes an autopilot software unit 308. Similar to autopilot software unit 204 in FIG. 2, autopilot software unit 308 includes a digital processor 309, which functions to execute suitable software instructions for controlling traffic flow by interpreting, processing and responding to vehicular operational data received from one or more other vehicles, and/or received or retrieved internally from one or more Digital Motor Electronic (DME) systems or an ECU of vehicle subsystem 300. An example of such software instructions for controlling traffic flow is described in detail below.

Example system 300 also includes a central processing unit 310 for the vehicle associated with (and conveying) system 300. For this embodiment, central processing unit 310 is a digital processor that can be implemented with the vehicle's central computer, but the present invention is not intended to be so limited and can include the use of a separate digital processor (e.g., microprocessor, microcontroller, etc). that can provide certain vehicular operational parameters, such as the vehicle's current linear velocity and weight. As such, other vehicular operational parameters can also be provided for system 300 by an onboard GPS receiver 312 (e.g., instantaneous latitudinal and longitudinal coordinates), and a 6 Degrees Of Freedom (6DOF) Inertial Measurement Unit (IMU) 314 (e.g., a gyroscope system that senses and forwards a vehicle's roll, pitch, yaw data, associated acceleration data, and x, y, z acceleration data).

Thus, for this example embodiment, autopilot software unit 308 can retrieve and/or receive internal vehicular operational data from central processing unit 310, onboard GPS receiver 312, and 6DOF IMU 314 via respective data links 320, 322 and 324. Also, autopilot software unit 308 can send autopilot (traffic flow control) commands or instructions to the vehicle's central processing unit 310 via data link 320 (e.g., as an autopilot system to automatically control certain operational parameters, such as speed, acceleration, steering, braking, etc., if desired). Furthermore, autopilot software unit 308 can receive range and/or closing rate data from IR laser range finder unit 304 via data link 318, send and receive certain vehicular operational data (e.g., 6DOF data, latitudinal and longitudinal data, etc.) to/from other vehicles' traffic flow control systems (e.g., similar to system 300) via data link 316, wireless modem 302, and a TCP/IP/Ethernet data link 328 (e.g., using the vehicles' unique MAC/IP addresses), and send suitable messages for visual and/or audible display to an operator via data link 326 and display 306.

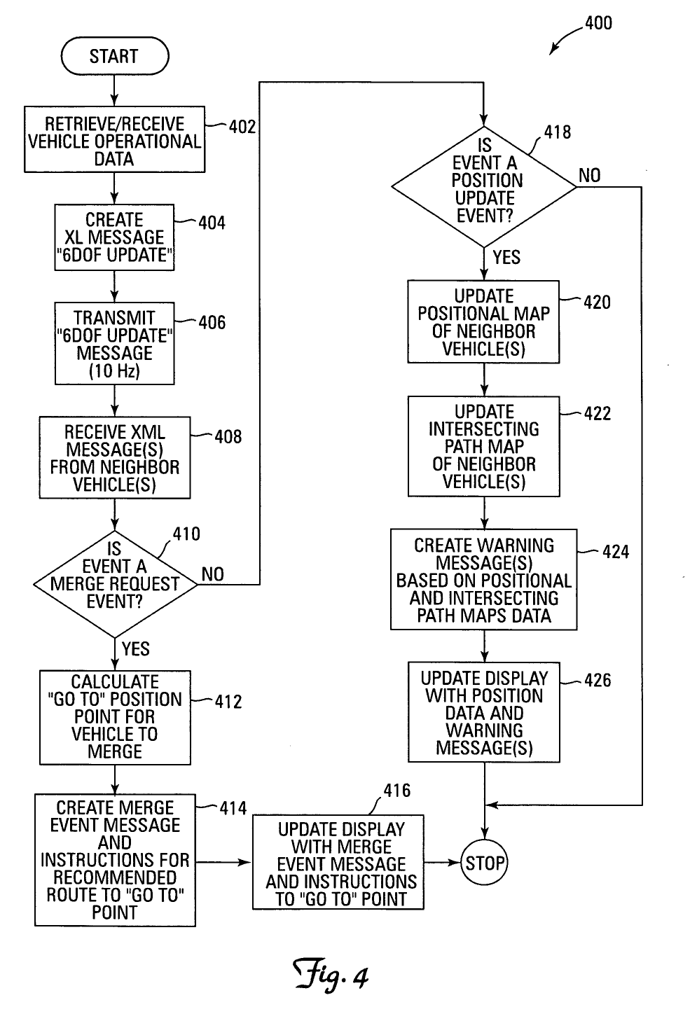

FIG. 4 depicts a flowchart of an example method 400 for controlling vehicle traffic flow, which can be used to implement pertinent autopilot software instructions that can be executed in autopilot software unit 204 in FIG. 2 (e.g., by digital processor 205) or autopilot software unit 308 in FIG. 3 (e.g., by digital processor 309), in accordance with a preferred embodiment of the present invention. Referring to FIGS. 3 and 4 for this example embodiment, method 400 begins by autopilot software unit 308 (e.g., digital processor 309) retrieving or receiving operational data for the vehicle associated with that traffic flow control system (step 402). For example, autopilot software unit 308 can retrieve or receive that data from the vehicle's central computer 310, onboard GPS receiver 312, and/or the 6DOF IMU 314. Using the operational data retrieved or received, autopilot software unit 308 creates a message “6DOFUpdate” for that vehicle in xml form (step 404). Autopilot software unit 308 then forwards that message to modem 302, which transmits the message (e.g., and that vehicle's latitudinal and longitudinal coordinates) over the wireless data communications link 328 (step 406). Thus, the “6DOFUpdate” and coordinate data for that vehicle can be received for processing by the vehicle traffic flow control systems (e.g., system 300) of the neighboring vehicle(s). Preferably, each vehicle's autopilot software unit 308 transmits such and update message at a regular frequency (e.g., 10 Hz).

Next, for this example embodiment, modem 302 receives and conveys to autopilot software unit 308 an event message (e.g., in xml form) from one or more neighboring vehicles (step 408). As such, for this embodiment, a received event message can include position update information for a neighboring vehicle, or a merge request made by a neighboring vehicle. However, it should be understood that the present invention is not intended to be so limited to just two such events, and an event message can include any suitable traffic flow control information that can be used by a vehicle traffic flow control system (e.g., system 300) either manually or automatically to enhance collision avoidance, traffic safety, minimize the distribution of vehicle velocities, and/or optimize traffic flow. Autopilot software unit 308 then determines whether or not the event in the message received from the neighboring vehicle is a merge request (step 410) or a position update (step 418). If (at step 410) the received message includes a merge request, then autopilot software unit 308 calculates a “go to” position point where the requesting “vehicle” can merge with the flow of vehicles in that adjacent queue (step 412). For example, referring to FIG. 1, if the operator of vehicle 104 (e.g., the autopilot software unit for vehicle 104) determines that one or more vehicles ahead of vehicle 104 (e.g., vehicle 102) in the same lane is stopped or slowed down, and there is a potential merge point in an adjacent lane, then the autopilot software unit for vehicle 104 can calculate the position where vehicle 104 can “go to” in order to merge safely with the flow in that adjacent lane.

Next, for this example embodiment, autopilot software unit 308 creates a “merge” event message, which describes the event type and also includes suitable instructions for a recommended route to the “go to” point, if a merge point is available (step 414). For example, such instructions might state that the requesting vehicle merge into the right adjacent lane after the third vehicle in that lane passes by. If desired, the autopilot software unit 308 can also broadcast that merge event message to the appropriate neighboring vehicles in order to coordinate the merge. As an alternative, the merge instructions can include specific coordinates for the “go to” point, along with a recommended speed, etc. The autopilot software unit 308 then forwards the merge event message and recommended instructions to display 306 for the operator to view and/or hear (step 416).

Returning to step 410, if the received message is not a merge request event, then the autopilot software unit 308 determines whether or not the event is a position update event (step 418). If not, for this example embodiment, then method 400 can be terminated. Notably, again it should be understood that one or more additional types of event messages can be received and processed by autopilot software unit 308, and the present invention is not intended to be limited to just the two types of events described herein.

If (at step 418) the autopilot software unit 308 determines that the received event message (e.g., in xml form) is for a position update event, then the autopilot software unit 308 retrieves the 6DOF data and/or coordinate data from the received message, and updates a stored positional map including the most current positions of the neighbor vehicles (step 420). As described above, each vehicle's autopilot software unit 308 can be recognized by its unique MAC or IP address. Next, the autopilot software unit 308 updates a stored intersecting path map for the neighbor vehicles (step 422). For example, if a neighbor vehicle is moving to a merge point, then the intersecting path map illustrates that scenario for the host vehicle and other pertinent vehicles. The autopilot software unit 308 then creates one or more suitable warning messages based on the current vehicle position data and intersecting path data (step 424). The autopilot software unit 308 forwards the one or more warning messages and the updated vehicle positional map and intersecting path map data to display 306 for the operator to view and/or hear (step 426). The updated positional data and intersecting path map data can also be broadcast to neighboring vehicles, if desired.

For this example embodiment, the following example vehicle autopilot message protocol may be used for the above-described “6DOF Update” xml message:

```
<?xml version=”1.0” encoding=”US-ASCII”?>
<AAP_UPDATE>
  <6DOFUPDATE>
    <POSITION>
    <DATETIMEGROUP>20051014152232.001</DATETIMEGROUP>
    <LAT>+028.109</LAT>
    <LONG>−082.870</LONG>
    <ELEV>+000010.129</ELEV>
    <ROLL>+000.000</ROLL>
    <PITCH>+002.000</PITCH>
    <YAW>+179.000</YAW>
</POSITION>
<VELOCITY>
    <DATETIMEGROUP>20051014152232.058</DATETIMEGROUP>
    <LAT>−100.000</LAT>
    <LONG>−000.500</LONG>
    <ELEV>+000.000</ELEV>
    <ROLL>+000.000</ROLL>
    <PITCH>+000.000</PITCH>
    <YAW>+000.000</YAW>
</VELOCITY>
<ACCELERATION>
    <DATETIMEGROUP>20051014152232.116</DATETIMEGROUP>
    <LAT>−001.000</LAT>
    <LONG>−000.000</LONG>
    <ELEV>+006.000</ELEV>
    <ROLL>+000.000</ROLL>
        <PITCH>+000.000</PITCH>
        <YAW>+000.000</YAW>
    </ACCELERATION>
  </6DOFUPDATE>
</AAP_UPDATE>
```

For this example embodiment, the following example vehicle autopilot message protocol may be used for the above-described “merge request” xml message:

```
<?xml version=”1.0” encoding=”US-ASCII”?>
<AAP_UPDATE>
  <MERGE_REQUEST>
  <POSITION>
    <DATETIMEGROUP>20051014152232.001</DATETIMEGROUP>
    <LAT>+028.109</LAT>
    <LONG>−082.870</LONG>
    <ELEV>+000010.129</ELEV>
    <ROLL>+000.000</ROLL>
    <PITCH>+002.000</PITCH>
    <YAW>+163.000</YAW>
  </POSITION>
  <VELOCITY>
    <DATETIMEGROUP>20051014152232.058</DATETIMEGROUP>
    <LAT>−100.000</LAT>
    <LONG>−001.200</LONG>
    <ELEV>+000.000</ELEV>
    <ROLL>+000.000</ROLL>
    <PITCH>+000.000<PITCH>
    <YAW>+000.000</YAW>
  </VELOCITY>
  <ACCELERATION>
    <DATETIMEGROUP>20051014152232.116</DATETIMEGROUP>
    <LAT>−001.000</LAT>
    <LONG>−000.000</LONG>
    <ELEV>+006.000</ELEV>
    <ROLL>+000.000</ROLL>
    <PITCH>+000.000</PITCH>
    <YAW>+000.000</YAW>
  </ACCELERATION>
  </MERGE_REQUEST>
</AAP_UPDATE>
```

In summary, the present invention provides a vehicle traffic flow control system, in which a plurality of vehicles (e.g., motor vehicles, aircraft, etc.) can communicate operational data to each other using a traffic flow control communication protocol. Thus, each vehicle “knows” what its neighboring vehicles are doing, and if such a vehicle is operating in an autopilot mode, it can respond significantly faster to other vehicles' movements than a vehicle's operator can. As such, each vehicle in the system can be identified by a unique MAC or IP address, and the vehicles can coordinate their travel together. Consequently, the present invention provides a form of “wireless” train, which is a network or queue of vehicles moving together. Notably, a vehicle can join the system by inserting itself into a queue, and immediately that vehicle can begin communicating and coordinating with the other vehicles in the queue (e.g., similar to connecting a mobile computer to the Internet or a wireless LAN). Also, the vehicle communication part of the traffic flow control system can be implemented using a typical network communication protocol, such as, for example, an Ethernet, TCP/IP, or LAN communication protocol.

Advantageously, the vehicle traffic flow control system of the present invention resolves the “slinky” effect problem in traffic queues, because the vehicular LAN (e.g., network of communicating vehicles) can coordinate the velocities of the vehicles in a perturbed lane, in order to diminish the distribution of vehicles' velocities. In other words, by communicating a “slow down” message to vehicles that have not yet arrived at a blockage in a lane, the overall velocity of the vehicles in the lane can be “smoothed out” to reduce the “slinky” effect and thus increase the overall average velocity of the vehicles in the lane.

As another advantage, the vehicle traffic flow control system of the present invention resolves the rear-end “pile-up” problem in traffic queues, because the vehicular LAN can coordinate the velocities of the vehicles in a perturbed lane (e.g., by sharing vehicles' positions, velocities and accelerations/decelerations) so that the queue of vehicles can be slowed down simultaneously to avoid a “pile-up” type of accident. Also, the vehicular LAN can coordinate the movement of vehicles in adjacent lanes, in order to create suitable space for swerving vehicles, and/or simultaneously slow the vehicles down as the “shear” with the adjacent lane(s) increases (e.g., a large difference in the average velocity of the vehicles in the two lanes). Similarly, the vehicle traffic flow control system of the present invention resolves the “start up” traffic flow problem, because the vehicular LAN can coordinate the accelerations of the vehicles in a lane (e.g. at the onset of a green light) so that the vehicles can accelerate simultaneously and thus improve the response times of the vehicles in the lane.

As yet another advantage, the vehicle traffic flow control system of the present invention resolves the “pulsating” flow problem caused typically by multiple stop lights in a traffic queue. For example, the vehicular LAN can coordinate the velocities and accelerations of the vehicles in the periodically stopped lane(s) in order to decrease the distribution of the vehicles' velocities. By communicating the existence of the “stop lights” to vehicles that have not yet arrived at those stop lights, the average velocity of the vehicles in the lane is “smoothed out”, which diminishes the “pulsating” effect and increases the overall average velocity of the vehicles in the lane. Thus, vehicles do not have to come to a complete stop, because the vehicular LAN controls the traffic flow so as to synchronize the flow with the timing of the traffic lights.

Also, the vehicle traffic flow control system of the present invention resolves a number of other existing traffic flow problems. For example, if a vehicle is not equipped to communicate with the vehicular LAN, the present invention can reduce the potential danger of this vehicle to the vehicles within the LAN, by monitoring (e.g., with one or more vehicles' laser range finders) the position, velocity and acceleration of such a non-networked vehicle. Thus, the vehicular LAN can coordinate a safe response, for the vehicles communicating in the LAN, to the position, velocity and acceleration information for the non-networked vehicle(s) involved. As another example, during poor driving conditions (e.g., fog, rain, snow, sleet, etc.), the vehicular LAN can coordinate (e.g., by sharing vehicles' positions, velocities and acceleration rates) a safe response to such driving conditions, by increasing the distance between vehicles, and suggesting or controlling the vehicles' responses to traffic events (e.g., by providing an early warning about adverse events that are beyond the visibilities or stopping distances of the vehicles involved). As still another example, the vehicular LAN can increase highway capacity, by decreasing the “safe distance” required between vehicles. In other words, the LAN can coordinate the distances between vehicles and the vehicles' acceleration rates, in order to keep traffic moving (e.g., thus over-riding “cautious human responses” that significantly degrade traffic flow).

It is important to note that while the present invention has been described in the context of a fully functioning system for controlling vehicular traffic flow, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular system for controlling vehicular traffic flow.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for controlling vehicular traffic flow, comprising:
a plurality of data communication links; and
a plurality of vehicles, each vehicle of said plurality of vehicles coupled to at least one other vehicle of said plurality of vehicles by at least one data communication link of said plurality of data communication links, each vehicle of said plurality of vehicles including:
a modem unit;
an autopilot software unit coupled to said modem unit; and
means, coupled to said autopilot software unit, for deriving operational data for said vehicle.

2. The system of claim 1, wherein at least one vehicle of said plurality of vehicles further includes means, coupled to said autopilot software unit, for determining a distance to a second vehicle of said plurality of vehicles.

3. The system of claim 1, wherein said modem unit comprises a wireless transceiver.

4. The system of claim 1, wherein said modem unit comprises a wireless transceiver operable to transmit and receive data in accordance with an IEEE 802.11b/g data communication protocol.

5. The system of claim 1, wherein said modem unit is operable to transmit and receive vehicle operational data via said at least one data communication link.

6. The system of claim 1, wherein said means for deriving operational data includes at least one of a vehicle central computer unit, a GPS receiver unit, and a 6DOF Inertial Measurement Unit.

7. The system of claim 1, wherein said modem unit comprises an IR transmitter and receiver.

8. The system of claim 1, wherein said operational data comprises at least one of a velocity, acceleration rate, deceleration rate, weight, pointing vector, angular velocity, roll, pitch, yaw, latitude and longitude measurement value for said vehicle.

9. The system of claim 1, wherein at least one vehicle of said plurality of vehicles further includes an infrared laser range finder operable to determine a distance to a second vehicle of said plurality of vehicles.

10. The system of claim 1, wherein said modem unit is operable to transmit and receive said operational data in an xml format.

11. The system of claim 1, wherein said plurality of vehicles comprises a plurality of aircraft.

12. An autopilot system for a vehicle, comprising:
means for transmitting operational data associated with said vehicle and receiving operational data associated with a second vehicle;
means for deriving said operational data associated with said vehicle;
means for determining a distance to said second vehicle; and
means for processing and responding to said received operational data associated with said second vehicle, coupled to said means for transmitting and receiving, said means for deriving, and said means for determining.

13. The autopilot system of claim 12, wherein said means for transmitting and receiving comprises a wireless transceiver.

14. The autopilot system of claim 12, wherein said means for transmitting and receiving comprises an infrared data communications modem.

15. The autopilot system of claim 12, further comprising:
means for displaying an autopilot event message to an operator of said first vehicle.

16. The autopilot system of claim 12, wherein said means for determining a distance comprises an infrared laser range finder.

17. The autopilot system of claim 12, wherein said means for deriving comprises at least one of a DME, ECU, gyroscope system, and central computer.

18. The autopilot system of claim 12, wherein said vehicle and said second vehicle comprise aircraft.

19. A method for controlling vehicle traffic flow, comprising the steps of:
retrieving vehicle operational data;
creating a first message including said retrieved vehicle operational data;
transmitting said first message;
receiving a second message;
determining if said second message includes a merge request;
if said second message includes a merge request, calculating a go to position point, creating a merge event message and go to position point instructions, and displaying said merge event message and said go to position point instructions;
if said second message does not include a merge request, determining if said second message includes a position update; and
if said second message includes a position update, updating a positional map and an intersecting path map associated with at least one neighbor vehicle, creating a warning message associated with said position update, and displaying said warning message and data associated with said positional map and intersecting path map update.

20. The method of claim 19, wherein said first message and said second message are created in an xml format.

21. The method of claim 19, wherein said first message comprises a 6DOF Update message.

22. The method of claim 19, wherein said position update comprises a 6DOF Update message.

23. The method of claim 19, wherein said second message comprises an event message.

24. The method of claim 19, wherein the vehicle traffic flow comprises aircraft traffic flow.

25. A computer program product, comprising:
a computer-usable medium having computer-readable code embodied therein for configuring a computer processor, the computer program product comprising:
a first executable computer-readable code configured to cause a computer processor to retrieve vehicle operational data;
a second executable computer-readable code configured to cause a computer processor to create a first message including said retrieved vehicle operational data;
a third executable computer-readable code configured to cause a computer processor to transmit said first message;
a fourth executable computer-readable code configured to cause a computer processor to receive a second message;
a fifth executable computer-readable code configured to cause a computer processor to determine if said second message includes a merge request;
a sixth executable computer-readable code configured to cause a computer processor to calculate a go to position point, create a merge event message and go to position point instructions, and display said merge event message and said go to position point instructions, if said second message includes a merge request;
a seventh executable computer-readable code configured to cause a computer processor to determine if said second message includes a position update, if said second message does not include a merge request; and
an eighth executable computer-readable code configured to cause a computer processor to update a positional map and an intersecting path map associated with at least one neighbor vehicle, create a warning message associated with said position update, and display said warning message and data associated with said positional map and intersecting path map update, if said second message includes a position update.

26. The computer program product of claim 25, wherein said vehicle operational data comprises aircraft operational data, and said at least one neighbor vehicle comprises at least one neighbor aircraft.
